(19) United States
(12) Patent Application Publication
(10) Pub. No.: US 2014/0045158 A1
(43) Pub. Date: Feb. 13, 2014

(54) System And Method For Associating Auditory Stimuli With Visual Depictions

(71) Applicant: Tammy Zietchick Movsas, Southfield, MI (US)

(72) Inventor: Tammy Zietchick Movsas, Southfield, MI (US)

(21) Appl. No.: 13/952,563

(22) Filed: Jul. 26, 2013

Related U.S. Application Data
(60) Provisional application No. 61/681,990, filed on Aug. 10, 2012.

(51) Int. Cl. G09B 5/06; G09B 19/00

(52) U.S. Cl. CPC G09B 5/067; G09B 19/00
USPC 434/236

(57) ABSTRACT

A system and method for associating auditory stimuli with visual depictions. The system includes a display, computing environment, and means to audibly play music. The system and method enable a user to learn to associate selected pieces of music with corresponding facial expressions, practice the learned associations, and play chosen pieces of music based upon the learned associations.

### CROSS-REFERENCE TO RELATED APPLICATIONS

This application claims the priority benefit of U.S. Provisional Application 61/681,990 filed Aug. 10, 2012, which is herein incorporated by reference in its entirety.

### TECHNICAL FIELD

The technology described herein relates generally to learning systems. In particular, the technology described herein pertains to systems and methods directed to associating sounds, especially music, with visual representations, especially facial expressions.

### BACKGROUND

Recognition and interpretation of visual cues, notably facial expressions, are critical for development of interpersonal skills. Certain groups are at risk for normal development (or re-development) in this area.

a. Individuals (children and adults) with Autism Spectrum Disorder (ASD)

b. Down's syndrome individuals

c. traumatized individuals

d. individuals with certain head injuries

e. some stroke patients

f. individuals with certain psychological disorders

g. elderly suffering from dementia, Alzheimer's, or other memory impairments

In particular, children and adults with ASD perform worse on tests of face and emotion recognition. Making and maintaining friendships often proves to be difficult for those with ASD. People with ASD have social impairments and often lack the intuition about others that most people take for granted.

While people with ASD, especially those with Asperger's' (and also those with Down's syndrome), have a lot of problem in recognizing facial expressions, most do not have difficulty with music. In fact, many ASD individuals are particularly gifted in music.

Autism Spectrum Disorder (ASD) is a highly variable neurodevelopmental disorder that first appears during infancy or childhood, and generally follows a steady course without remission. People with ASD have social impairments and often lack the intuition about others that many people take for granted. Unusual social development becomes apparent early in childhood. Infants who are later diagnosed with ASD show less attention to social stimuli, smile and look at others less often, and respond less to their own name. Autistic toddlers differ more strikingly from social norms; for example, they have less eye contact and turn taking, and do not have the ability to use simple movements to express themselves, such as the deficiency to point at things. Three- to five-year-old autistic children are less likely to exhibit social understanding, approach others spontaneously, imitate and respond to emotions, communicate nonverbally, and take turns with others.

Related patents and published patent applications known in the background art include the following:

U.S. Pat. No. 4,945,805, issued to Hour on Aug. 7, 1990, discloses an electronic music and sound mixing device, to be combined with a doll or a toy animal. The device comprising a mix ROM and a speech ROM for storing digital data of melodies, accompaniments and animal voices, a logical control circuit for controlling the operation of this device responsive to external signals to play a single song or all of the stored songs, once or continuously. The devices further include melody and accompaniment-generators for treating the digital data read from the mix ROM and couples their output to a mix circuit which mixes the signals and shapes them into square waves for coupling to an amplifier for generating an audio output. The device can also output synchronized signals simultaneously to drive a motor to give facial expressions and limb movements to the toy animal in accordance with the song played.

U.S. Pat. No. 6,149,490, issued to Hampton et al. on Nov. 21, 2000, discloses a very compact interactive toy is provided that provides highly life-like and intelligent seeming interaction with the user thereof. The toy can take the form of a small animal-like creature having a variety of moving body parts that have very precisely controlled and coordinated movements thereof so as to provide the toy with life-like mannerisms. The toy utilizes sensors for detecting sensory inputs which dictate the movements of the body parts in response to the sensed inputs. The sensors also allow several of the toys to interact with each other. The body parts are driven for movement by a single motor which is relatively small in terms of its power requirements given the large number of different movements that it powers. In addition, the motor is reversible so that the body parts can be moved in a non-cyclic life-like manner. For space conservation, a cam operating mechanism is provided that is very compact with the cam mechanisms for the parts all operated off of a single small control shaft of the cam operating mechanism, e.g. approximately one inch in length, driven for rotation by the single, low power motor.

U.S. Pat. No. 6,554,679, issued to Shackelford et al. on Apr. 29, 2003, discloses an interactive doll simulates the character of a live person or, in other embodiments a fantasy figure or animal, in essence, simulating a living being that possesses respective human or animal qualities: displaying specific needs, tenderness, intelligence and/or understanding. The doll contains a clock or other timekeeping device and thereby knows of the time of day. It automatically enters a sleep mode at a preset sleep time during which the play-toy remains quiet, and wakens at a preset hour of the day, issuing a verbal statement to let the player know it is time to again play. By issuing a sequence of verbal requests from time to time to the player to take action of various kinds on or with the doll, determines the player's compliance or noncompliance with each such request and issues a verbal message appropriate to such compliance or noncompliance. Some of the verbal requests made are of a kind that occur at a particular time of day in the life of the character being synthesized, such as a request for a food or beverage at breakfast time, lunch time or supper time. And, from time to time at its own initiative, the play-toy may issue verbal messages of affection to the player. That doll is accompanied by external objects that simulate a variety of foods, a beverage, medicine and the like, which the doll is to be applied by the player to the doll pursuant to specific verbal requests from the doll and the doll is able to identify those objects for enhanced interactive play with the player.

U.S. Pat. No. 7,607,097, issued to Janakiraman et al. on Oct. 20, 2009, discloses a method for incorporating emotional information in a communication stream by receiving an emotional state indicator indicating an emotional state of a presenter in a communication session, retrieving a cultural profile for the presenter, retrieving a plurality of cultural profiles corresponding to each of several recipients in the communication session, for each recipient, translating the emotional state indicator into a corresponding emoticon according to a difference between the cultural profile of the presenter and the cultural profile of each recipient, merging the translated emoticon into a copy of the communication session, and presenting communication session and merged translated emoticon to each recipient.

U.S. Pat. No. 8,094,891, issued to Andreasson on Jan. 10, 2012, discloses a method may include playing a first song on a device, capturing an image of a user, performing facial expression recognition of the user based on the image, and selecting a second song based on a facial expression of the user.

U.S. Published Patent Application No. 2006/0270312, inventor Maddocks et al., published on Nov. 30, 2006 discloses a very compact interactive animated character is provided that provides highly life-like and intelligent seeming interaction with the user thereof. The animated character can take the form of a small animal-like creature having a variety of moving body parts including a smile/emotion assembly which are coordinated to exhibit life-like emotional states by precisely controlling and synchronizing their movements in response to external sensed conditions. The animated character also includes sound generating circuitry to generate speech sounds as well as sounds associated with various emotional states, which are coordinated with a lip sync assembly simulating speech mouth movement. The drive system utilizes first and second reversible motors which are able to power and precisely coordinate the lip sync assembly producing speech mouth movement, with the movable parts and the smile/emotion assembly to produce life-like interactions and emotional expressions.

U.S. Published Patent Application No. 2007/0128979, inventor Shackelford et al, published on Jun. 7, 2007, discloses a high-tech doll produces humanlike expressions, recognizes words, and is able to carry on a conversation with a living person, as example, addresses time based subjects, such as the food to eat at various times of the day, and expresses attitudes, emulating a living child. A child player acquires an emotional bond to the doll whilst the doll appears to bond to the child. The doll exhibits facial expressions produced concurrently with spoken words or separately to provide body language, representing emotions, such as happiness, sadness, grief, surprise, delight, curiosity, and so on, reinforcing the emulation of a living child. Additional features add to the play.

U.S. Published Patent Application No. 2008/0311969, inventor Kay et al., published on Dec. 18, 2008, discloses Systems and methods for displaying cues indicating input actions in a rhythm-action game may include: displaying, to a player of a rhythm-action game, a lane divided into at least two sub-lanes, each sub-lane containing cues indicating a drum input element; and displaying, to the player, an additional cue spanning a plurality of the sub-lanes, the additional cue indicating a foot pedal action. In some embodiments, the additional cue may span all the sub-lanes. In some embodiments, each sub-lane may contain cues indicating a drum input element of a set of linearly arranged drum input elements. In other embodiments, each sub-lane may correspond to a fret button of a simulated guitar and the additional cue may correspond to an open strum.

U.S. Published Patent Application No. 2011/0028216, inventor Sarig et al., published on Feb. 3, 2011, discloses a method for a timing exercise performed on one of a dedicated player handset with screen and appropriate programming and a PC having appropriate programming and a screen, wherein a song is played, and wherein at least one sensor is provided to monitor activities of at least one participant. The method includes showing representations of the musical elements of the song on the screen of the dedicated player and recognizing at least one of the movements, facial expressions, body language, speech and identity of at least one participant; and as a result causing the representations to be “activated” by the participant, in the right order, at the right time and over the right duration.

The book “What's That Look on Your Face” by Snodgrass, ISBN-13 978 1934575277, “helps young readers link faces to feelings by presenting situations they can all relate to. Each page spread is devoted to a feeling expressed through an exaggerated facial expression accompanied by a short poem that further elaborates on the expression to reinforce its meaning.”

### BRIEF SUMMARY OF THE INVENTION

The system for associating auditory stimuli with visual depictions comprises: a display configured to provide a user with one or more facial expressions and enable the user to select one of the facial expressions if prompted, wherein each facial expression corresponds to a mood and a dynamism; a computing environment configured to generate a distinct piece of music corresponding to each facial expression; and means to audibly play the distinct piece of music.

In one embodiment, the display comprises a computing environment screen such as tablet screen, smartphone screen, personal computer screen, or the like. The user would be able to select a facial expression from a plurality of choices which are concurrently shown on the screen.

In one embodiment, the display comprises a plurality of facial expressions, wherein each facial expression is positioned at a proximal end of a pull ring assembly. A user selection can be generated by pulling a selected pull ring assembly.

Examples of mood are happy, sad, scared, peaceful, or the like.

Examples of dynamism are fast, slow, medium, static, or the like.

Music tempo can vary to match the level of dynamism while maintaining an overall sound which matches the mood of a facial expression.

Means to audibly play the corresponding piece of music can be speakers or the like which are linked to the computing environment via wired or wireless communications.

The computing environment can be configured to generate the piece of music before the one or more facial expressions are shown to the user, during a period of time when the facial expression is shown to the user, or after the one or more facial expressions are shown to the user.

In one embodiment, music is played during the period of time a facial expression is shown to a user. This is to teach the user to associate a particular piece of music with a particular facial expression.

In one embodiment, the piece of music is played before the one or more facial expressions are shown to the user. This enables the user to select the facial expression which corresponds to the piece of music. The computing environment can further comprise the ability to output a signal which corresponds to a reward for selecting the correct facial expression. The reward can be a light, tone, piece of candy, or the like.

In one embodiment, the piece of music is played after the one or more facial expressions are shown to the user. The computing environment then plays the piece of music which corresponds to the user's facial expression selection.

The method for associating auditory stimuli with visual depictions comprises: providing a display configured to provide a user with one or more facial expressions and enable the user to select one of the facial expressions if prompted, wherein each facial expression corresponds to a mood and a dynamism; providing a computing environment configured to generate a distinct piece of music corresponding to each facial expression; and providing means to audibly play the distinct piece of music.

The scope of the invention is defined by the claims, which are incorporated into this section by reference. A more complete understanding of embodiments on the present disclosure will be afforded to those skilled in the art, as well as the realization of additional advantages thereof, by consideration of the following detailed description of one or more embodiments. Reference will be made to the appended sheets of drawings that will first be described briefly.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 is an elevational view of an infant gym arrangement in which pulling a particular ring activates music that corresponds to the face above the ring, according to an embodiment of the technology described herein.

FIG. 2 is a front plan view of an infant gym arrangement embodiment.

FIG. 3 illustrates an infant pulling on a ring and music being generated.

FIG. 4 illustrates the infant in FIG. 3 pulling on a different ring and different music being generated.

FIG. 5 illustrates a user about to utilize a touch screen on a tablet computer in order to generate music that corresponds to a face displayed on the touch screen; according to an embodiment of the technology described herein.

FIG. 6 illustrates the user of FIG. 5 activating music that corresponds to the face that is touched.

FIG. 7 illustrates the user of FIG. 5 activating different music corresponding to different faces.

FIG. 8 is a block diagram of a typical computing environment used for implementing embodiments of the present disclosure.

FIG. 9 is a flow chart depicting an embodiment of the method described herein.

### DETAILED DESCRIPTION OF THE INVENTION

The technology described herein pertains to learning systems that facilitates improvement in the ability to recognize facial expressions by making use of corresponding music therapy.

Besides individuals with ASD, there are several other groups of individuals that are known to have trouble with facial expression recognition such as (but not limited to) individuals with Trisomy 21, individuals with schizophrenia, individuals with depression. While the technology described herein is beneficial for individuals with ASD, it can also benefit anyone wanting to further develop their recognition and interpretation of facial expressions.

A facial expression is a gesture executed with the facial muscles usually with the conscious or unconscious intent of expressing a feeling. There are 6 basic emotions [(a) joy, (b) anger, (c) sadness, (d) surprise, (e) disgust and (f) fear] and an unlimited number of blended motions which are combinations thereof (such as enthusiasm, frustration, evilness, or the like) that can be portrayed by facial expressions. Examples of facial expressions that usually (but not always) recognized by most people include (but are not limited to): “a look of triumph”; “an angry face”, a gape as an expression of openmouthed astonishment; a grin or smile as an expression of pleasure or amusement; a wince as an expression of sudden pain.

For the purpose of this patent application, we will define “Facial dynamisms” as facial expressions that are either static facial expressions (such as a snapshot of a given facial expression at a given moment in time on a human, animal or virtual character) or dynamic facial expressions (i.e. evolving or changing facial expressions in a moving person, animal or virtual character). An example of a dynamic facial expression would be the facial expression that evolves as one is “becoming happy’; the corners of the mouth may begin to turn up as the expression of the face evolves from a neutral state to a happy state.

The perception of emotion expressed by a facial dynamism may be influenced by one or more of the following variables (but not limited to):
1. race/culture/ethnicity of the individual making the facial expression
2. race/culture/ethnicity of the individual perceiving the facial expression
3. age of individual perceiving the facial expression
4. sex of individual perceiving the facial expression
5. face morphology (i.e. male versus female face)
6. distance from which facial expression is viewed (i.e. 1 meter versus 3 meters)
7. geometric intensity (i.e. a “hint of a smile” versus a “huge grin”)
8. viewing angle (i.e. frontal versus lateral view)
9. textual context (i.e. the action of the individual while making the facial expression)
10. facial muscle anomalies or pathology (i.e. paresis or paralysis of certain facial muscles would affect facial expression)
11. consciousness of individual perceiving the facial expression
12. consciousness of individual making the facial expression

For the purposes of this systems and methods directed to associating sounds, especially music, with visual representations, especially facial expressions, the facial dynamisms that will be utilized will either have been previously scientifically tested and validated or will be empirically determined to represent a particular emotion by testing the facial expressions on different cohorts of average individuals of different ages, ethnicities, after controlling for some of the variables described above. Thus the facial dynamisms will either have been or will be experimentally determined to represent the expression of a particular emotion as determined by a majority response of average study participants. We will define “average individuals” as individuals who do not fall into a category of people who are known to have difficulty with interpreting facial expressions such as, but not limited to, individuals with autism, individuals with depression, individuals with Parkinson's disease, individuals with schizophrenia, and individuals with Trisomy 21.

Music has been characterized as a language of emotions. Emotional recognition in music is a common and almost automatic process that occurs after the presentation of a 500 ms musical excerpt. This has has been scientifically shown to occur in children as young as 3 years old as well as in listeners completely unfamilar with the musical system in which those emotions are expressed It has been shown that even infants can attend to emotion in the auditory modality. For example, 7 month old infants attend more intensely to words spoken with an angry voice than to words uttered with a happy or neutral voice timbre as reflected by an early negative brain response. The basis for the universal reaction, especially to sad and happy emotions in music, is likely rooted in the acoustic features of the music. It has repeatedly been found that happy music is characterized by fast tempo and major mode, whereas sad music is typically played in slow tempo and minor mode. Additionally, performers use specific features to convey emotions while playing: sad emotions are typically expressed by soft dynamics, legato articulation, and soft tempo but happy, positive connotations of music are conveyed by staccato articulation and louder intensities. Also, sound effects can be superimposed onto musical pieces to express emotions. For example, an unexpected sound to an emotionally-neutral piece may express “surprise”. Also, basic emotion recognition in music can be affected by the presence of lyrics. Emotionally congruent lyrics contribute to the intensity of negatively perceived emotions compared to instrumental music alone (though this may not necessarily hold up for other emotions). For the purposes of this systems and methods directed to associating sounds, especially music, with visual representations, especially facial dynamisms, the music (which may or may not also contain lyrical content) that will be chosen will be pre-existing music that has been experimentally determined to induce a given emotion by a majority of average listeners (who may or may not have any musical training) or will be music written specifically for this purpose but will be tested to make sure that it induces the intended emotion by a majority of average listeners (who may or may not have any musical training or background). Examples of a musical training or background include the ability to play an instrument, read music, sing professionally, or the like.

Theory behind why the correlation of sound with visual representations will improve facial expression recognition skills in individuals with Autism Spectrum Disorder (ASD): Many of the impaired neural networks in ASD affect the cortical and subcortical regions that have been implicated in social cognition, and emotional processing and facial expression recognition. A few of these key brain regions are as follows:
1. Fusiform face area, within the occipitotemporal cortex, aids in face perception and recognition.
2. The superior temporal sulcus region analyzes eye and hand movement and allows interpretion and prediction of the actions and social intentions of others.
3. The amygdala, part of the limbic system, plays a key role in helping with the recognition of the emotional states of others especially thru analysis of facial expressions.

Diffusion tensor imaging of individuals with ASD confirms abnormalities within these aforementioned neural systems. A lack of connectivity among two or more of these neuranatomical structures supporting social cognition drives the emergence of social behavioral deficits in autism.

In order for us to develop a successful method to teach facial expression recognition, we need to be able to entrain the brain to rewire its abnormal circuitry. In days of old, the cascade of events that resulted in autism was believed to have progressed from genes to brain to behavior; thus, there was believed to have been a unidirectional flow of events. If this were true, then modification of behavior would not have the potential to affect brain function. However, by 2013, we recognize that pathways in this pathophysiological sequence are more accurately characterized as bidirectional. This allows for an individual's interaction with his environment to have the potential of modifying brain structure and function. A number of published studies support this conclusion:
1. Work in nonhuman primates demonstrates the malleability of brain mechanisms supporting social behavior. Monkeys who had been socially isolated for the first 6 months of life consistently displayed social behavior deficit along with odd, stereotyped behavior patterns, typical of human autism. However when these 6 month old social isolates were allowed to interact with 3 month old normal monkeys, they achieved total recovery of social function and regression of odd behaviors.
2. A recently published article (2012) in Journal of Autism and Developmental Disorders presents case reports of two children with ASD who underwent pivotal response treatment, an empirically validated behavioral treatment for ASD. After treatment, the children showed improvement on behavioral measures that correlated with increased activation of neural areas known to be involved with social cognition. Thus, these results demonstrate the plasticity of the neural mechanisms affecting social cognition in ASD children as old as five years of age.

Music is a critical element of this systems and method to teach facial expression recognition skills to individuals with ASD. In several studies, music has been shown to have the capacity to evoke strong positive and negative emotions in healthy subjects. In addition, neuroimaging studies have shown that music processing involves many of the same neural network of limbic and paralimbic structures implicated in social cognition. Therefore, since musical emotional processing has been shown to be preserved or even enhanced in autism, then music should be able to be used as a valuable tool in helping ASD individuals understand different types of emotion processing. For example, individuals with ASD show superior musical pitch processing. Spared musical skills exist both in autistic savants as well as in autistic individuals who are not savants. Individuals with ASD can properly identify the emotional valence of sad, happy, scared and peaceful music stimuliThus, individuals with ASD are able to understand musical emotions. Furthermore, case series studies and small randomized trials have shown that music therapy for autistic children can help autistic children learn social skills.

Of importance, neuroimaging scans taken of individuals with ASD while processing happy and sad music excerpts show activation of the same cortical and subcortical brain regions which are typically involved in facial emotion processing. We will take full educational advantage of this and also of the fact that music is a domain of preserved skills in autistic children. Since our systems and methods involve the correlation of music expression and facial expression, individuals with ASD will experience repeated activation of the neural areas that mediate emotional processing as they continue to view, listen and interact with our products that employ our method. Over time and with continued use of products that correlate musical emotion with facial emotion, their neural circuitry will become more adept at processing facial emotions and eventually, children with ASD will learn how to visually process facial emotion, eventually without the aid of musical cues.

The technology described herein has several embodiments, including, but not limited to:
1. a computer game utilizing software
2. an “app” for tablets, smartphones and the like
3. an electronic game device
4. a kick/pull game.

The technology described herein teaches an individual how to recognize a facial expression by matching facial expressions with musical expressions, e.g, when a happy face appears on the screen, happy music will play. When a surprised face appears on the screen, music with a “surprise” melody to it will play. This helps a user “feel” the facial expression (through music) and reinforces the internalization of what that particular facial expression represents. After a use has viewed several expressions several times, he/she are asked to match music to faces and faces to music.

It should be noted that individuals without facial expression difficulty benefit from this technology by learning more about musical expression by matching facial expressions to music.

The technology described herein is a great learning tool for any infant in the baby kick-gym embodiment. When an infant kicks a face, a musical piece that matches the facial expression will play. This helps infants develop musical appreciation at a young age.

The elements of the technology described here are:
1. a variety of pictures of different facial expressions (sad, happy, angry, surprised, etc.) featuring people of different ages, races, cultures, etc.
2. a variety of types of musical renditions that represent different expressions (happy music, sad music, angry music, etc.)
3. physical, electronic or software logic means to match each musical piece to a corresponding facial expression rendition
4. corresponding structure and/or rules based logic to generate different types of games to teach the linkage between the two.

Each embodiment will be tested on facial expression impaired individuals and normal development individuals of different demographics and modified based upon feedback.

Examples of how the technology described here can be used in different ways and for different age groups include the following:
1. A baby gym configured for an infant to either kick or pull on facial expressions to trigger music (which portrays that particular facial expression) to play. This embodiment may aid in infant brain development. An infant will learn both about facial expressions and also music appreciation (i.e. music can engender a mood response) and how the two can be equated.
2. Autistic individuals (all ages from toddler to adult) or other people who have trouble in recognizing facial expressions (such as Down's syndrome) or learning disabled individuals (from toddler, child, adult, elderly):
   A. software (computer game), app (for iPad, tablet) or a physical electronic game;
   B. a teaching mode in which different facial expressions plays with different music to match facial expression;
   C. numerous game modes in which either music plays and the player picks a facial expression, or a facial expression appears on the screen and the player chooses from several different choices of music.

In one exemplary embodiment of the technology described herein is a learning method for associating a visual depiction with auditory stimuli, the method comprising: a tablet computer having a touchscreen, the tablet computer comprising: learning method software installed on the tablet computer, the software configured for generating a plurality of a visual depiction of a face on the touchscreen; each visual depiction associated by the software to an auditory stimuli corresponding to the visual depiction; and an activation routine configured for playing the auditory stimuli corresponding to the visual depiction upon the visual depiction being touched on the touchscreen.

In another exemplary embodiment of the technology described here is a learning method for associating a visual depiction with auditory stimuli, the method comprising: an infant gym assembly, the infant gym assembly comprised of: a plurality of a pull ring assembly, each pull ring assembly comprised of: a pull ring at the proximal end of the pull ring assembly; a face display positioned above the pull ring; and a music generation assembly configured to generate music corresponding to the face display when activated.

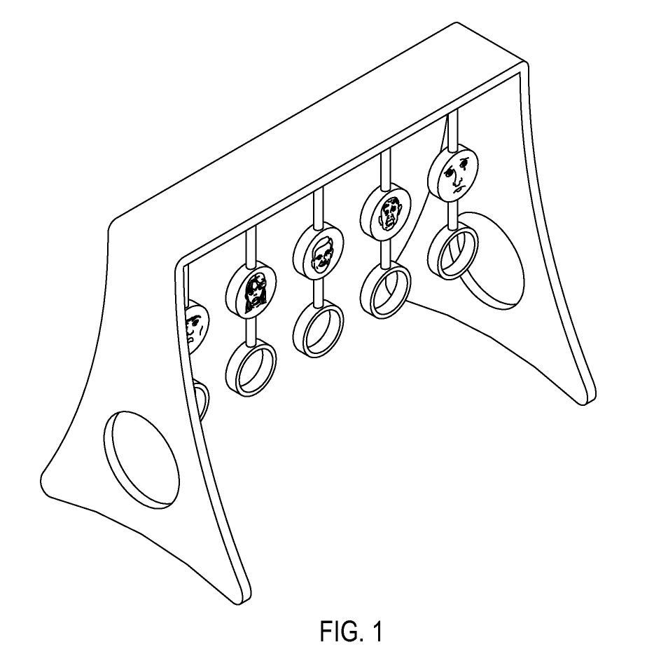

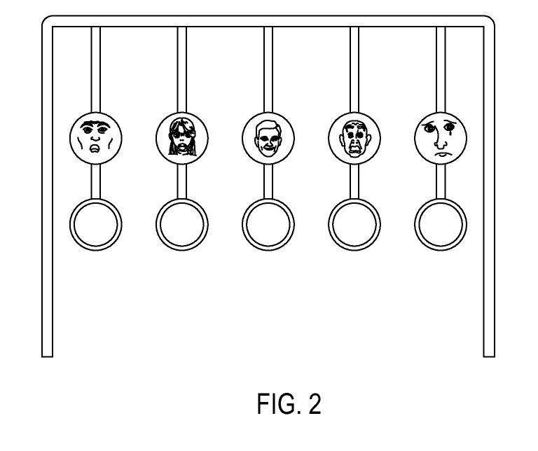

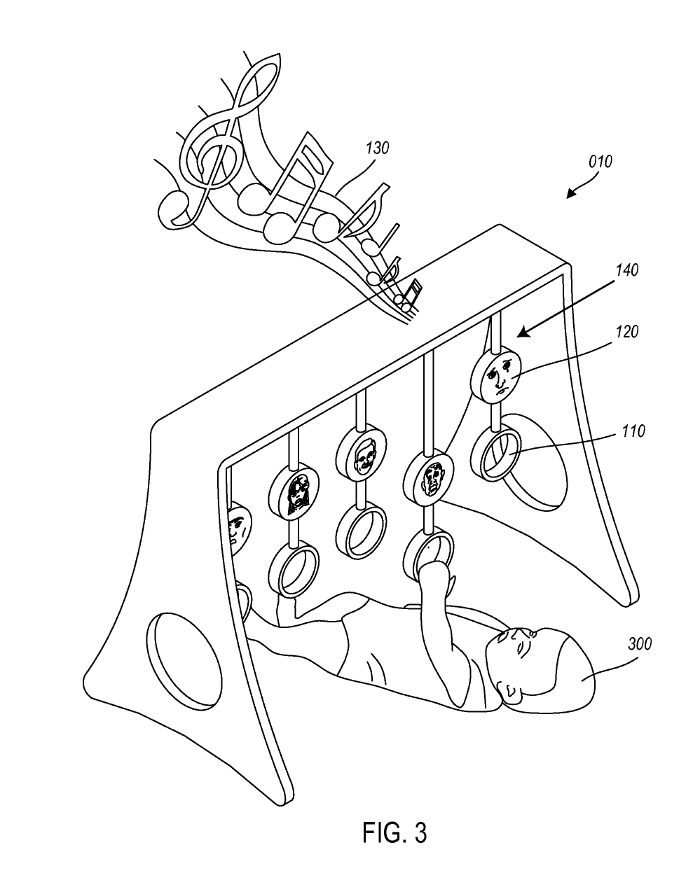

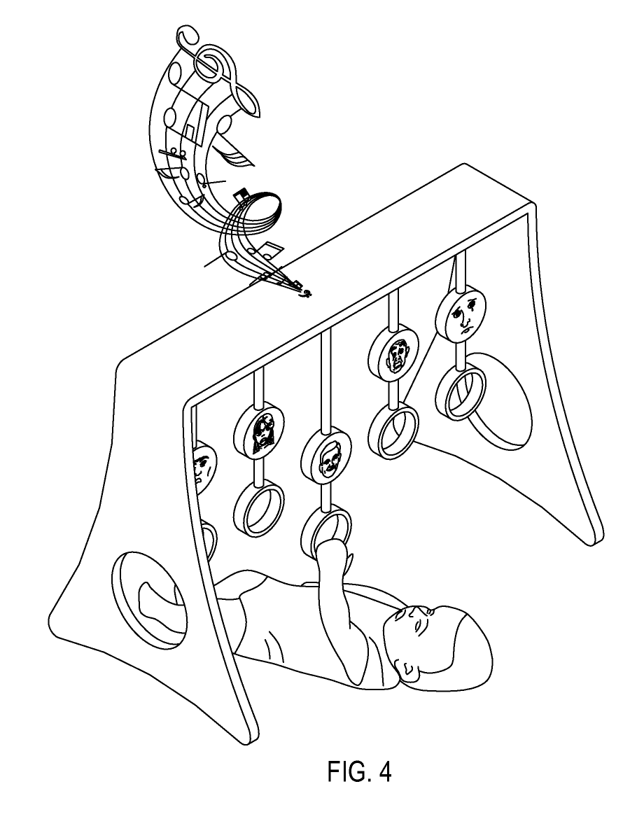

Referring now to FIGS. 1-4, illustrated therein is a schematic showing an infant gym assembly 010. The infant gym assembly is comprised of a plurality of pull ring assemblies 140. Each pull ring assembly is comprised of a pull ring 110 at the proximal end of the pull ring assembly 140 and a face display 120 situated above the pull ring 110. Each pull ring assembly 140 is further comprised of a music generation assembly that is configured to generate music 130 that corresponds to the face display 120 for that particular pull ring 110. A user 300 pulls on the pull ring 110 and learns to associate the music 130 with the face display 120.

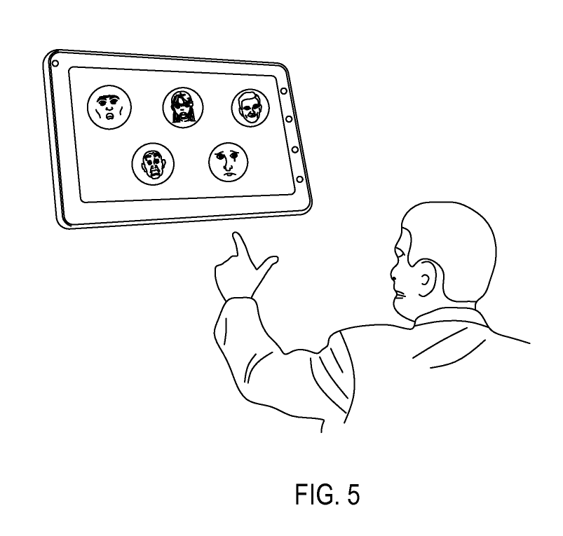

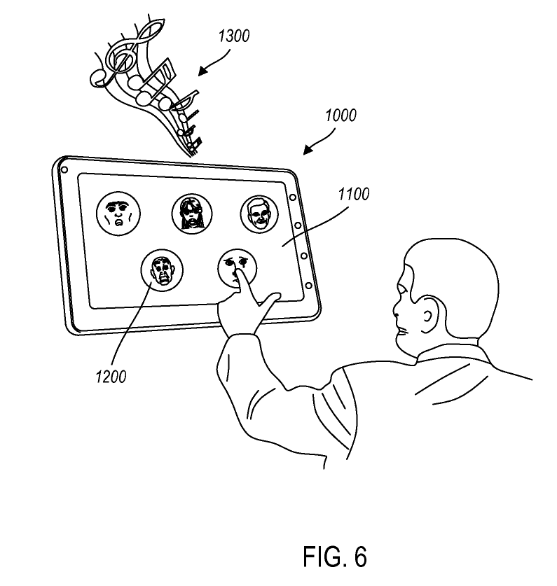

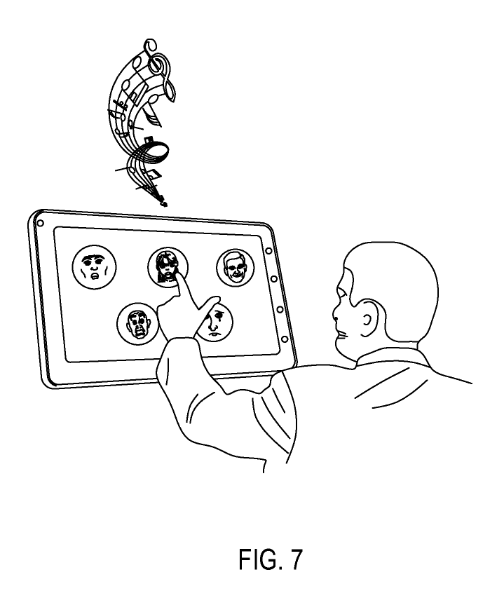

Referring now to FIGS. 5-7, illustrated therein is a schematic showing a tablet computer 1000 equipped with an embodiment of the technology described herein. The tablet computer 1000 is further comprised with software that displays a plurality of a face representation 1200. When each face representation 1200 is pressed on the touchscreen 1100, music 1300 is generated by the software that corresponds to that particular face representation 1200.

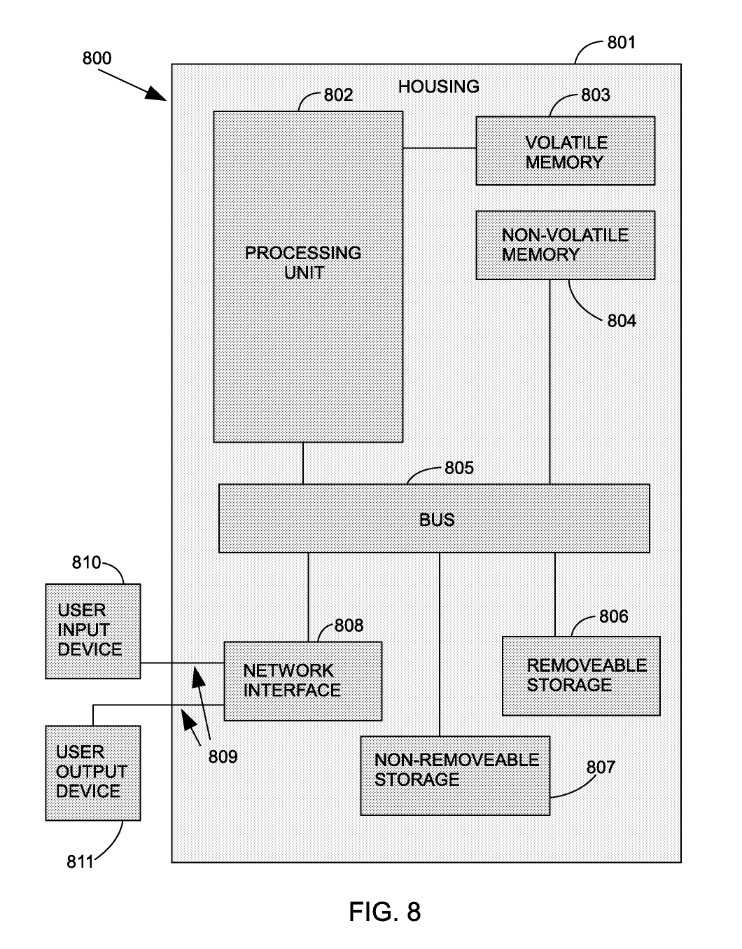

FIG. 8 is a block diagram of a typical computing environment used for implementing embodiments of the present disclosure. FIG. 8 shows a computing environment 800, which can include but is not limited to, a housing 801, processing unit 802, volatile memory 803, non-volatile memory 804, a bus 805, removable storage 806, non-removable storage 807, a network interface 808, ports 809, a user input device 810, and a user output device 811.

Various embodiments of the present subject matter can be implemented in software or applications, which may be run in the environment shown in FIG. 8 or in any other suitable computing environment. The embodiments of the present subject matter are operable in a number of general-purpose or special-purpose computing environments. Some computing environments include personal computers, server computers, hand-held devices (including, but not limited to, telephones and personal digital assistants (PDAs) of all types, iPods, and iPads), laptop devices, tablet devices, multi-processors, microprocessors, set-top boxes, programmable consumer electronics, network computers, minicomputers, mainframe computers, distributed computing environments, and the like to execute code stored on a computer readable medium. The embodiments of the present subject matter may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices. Internet connectivity includes 802.11, LAN network, dial-up network, mobile cellphone networks, cable internet, DSL, and satellite base Internet.

On the mobile Operating System (OS) platform, it supports Android from Google Inc., bada from Samsung Electronics, BlackBerry OS from RIM, iOS from Apple Inc., S40 (Series40) from Nokia, Symbian OS from Nokia and Accenture and Windows Phone from Microsoft.

A general computing device, in the form of a computer, may include a processor, memory, removable storage, non-removable storage, bus, and a network interface.

A computer may include or have access to a computing environment that includes one or more user input modules, one or more user output modules, and one or more communication connections such as a network interface card or a USB connection. The one or more output devices can be a display device of a computer, computer monitor, TV screen, plasma display, LCD display, display on a digitizer, display on an electronic tablet, and the like. The computer may operate in a networked environment using the communication connection to connect one or more remote computers. A remote computer may include a personal computer, server, router, network PC, a peer device or other network node, and/or the like. The communication connection may include a Local Area Network (LAN), a Wide Area Network (WAN), and/or other networks.

Memory may include volatile memory and non-volatile memory. A variety of computer-readable media may be stored in and accessed from the memory elements of a computer, such as volatile memory and non-volatile memory, removable storage and non-removable storage. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, memory sticks, and the like. Memory elements may also include chemical storage, biological storage, and other types of data storage.

“Processor” or “processing unit” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, an explicitly parallel instruction computing (EPIC) microprocessor, a graphics processor, a digital signal processor, program logic controller (PLC), field programmable gate array (FPGA), or any other type of processor or processing circuit. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc. for performing tasks, or defining abstract data types or low-level hardware contexts.

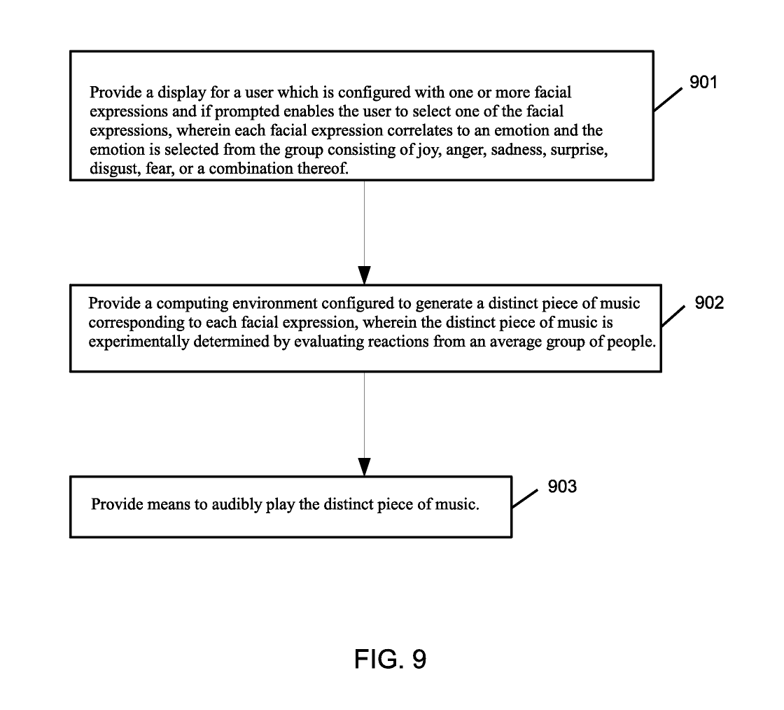

FIG. 9 is a flow chart depicting an embodiment of the method described herein. Step 901: providing a display for a user which is configured with one or more facial expressions and if prompted enables the user to select one of the facial expressions, wherein each facial expression correlates to an emotion and the emotion is selected from the group consisting of joy, anger, sadness, surprise, disgust, fear, or a combination thereof. Step 902: providing a computing environment configured to generate a distinct piece of music corresponding to each facial expression, wherein the distinct piece of music is experimentally determined by evaluating reactions from an average group of people. And Step 903: providing means to audibly play the distinct piece of music.

All patents and publications mentioned in the prior art are indicative of the levels of those skilled in the art to which the invention pertains. All patents and publications are herein incorporated by reference to the same extent as if each individual publication was specifically and individually indicated to be incorporated by reference, to the extent that they do not conflict with this disclosure.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations, and broad equivalent arrangements.

I claim:

1. A system for associating auditory stimuli with visual depictions, the system comprising:
a display configured to provide a user with one or more facial expressions and if prompted enable the user to select one of the facial expressions, wherein each facial expression correlates to an emotion and the emotion is selected from the group consisting of joy, anger, sadness, surprise, disgust, fear, or a combination thereof;
a computing environment configured to generate a distinct piece of music corresponding to each facial expression, wherein the distinct piece of music is experimentally determined by evaluating reactions from an average group of people; and
means to audibly play the distinct piece of music.

2. The system of claim 1, wherein the facial expressions further correlate to a facial dynamism.

3. The system of claim 2, wherein the computing environment is further configured with the capability to generate the piece of music before the one or more facial expressions are shown to the user, during a period of time when the facial expression is shown to the user, or after the one or more facial expressions are shown to the user.

4. The system of claim 3, wherein the computing environment is further configured to generate the piece of music partially based upon a user's selection performance, wherein the selection performance is a function of the user's experimentally determined ability to correctly select facial expressions corresponding to music.

5. The system of claim 3, wherein the computing environment is further configured to generate the piece of music partially based upon a user's selection performance, wherein the selection performance is an estimate of the user's ability to correctly select facial expressions corresponding to music.

6. The system of claim 3, wherein the computing environment is further configured to generate an output corresponding to a reward if the piece of music is generated before the one or more facial expressions are shown to the user and the user correctly selects the facial expression which corresponds to the piece of music.

7. The system of claim 3, wherein the display comprises a computing environment output screen.

8. The system of claim 3, wherein the display comprises a plurality of facial expressions and each facial expression is positioned at a proximal end of a pull ring assembly, wherein there is one facial expression for each pull ring assembly.

9. A method for associating auditory stimuli with visual depictions, the method comprising:
providing a display for a user which is configured with one or more facial expressions and if prompted enables the user to select one of the facial expressions, wherein each facial expression correlates to an emotion and the emotion is selected from the group consisting of joy, anger, sadness, surprise, disgust, fear, or a combination thereof;
providing a computing environment configured to generate a distinct piece of music corresponding to each facial expression, wherein the distinct piece of music is experimentally determined by evaluating reactions from an average group of people; and
providing means to audibly play the distinct piece of music.

10. The method of claim 9, wherein the facial expressions further correlate to a facial dynamism.

11. The method of claim 10, wherein the computing environment is further configured with the capability to generate the piece of music before the one or more facial expressions are shown to the user, during a period of time when the facial expression is shown to the user, or after the one or more facial expressions are shown to the user.

12. The method of claim 11, wherein the computing environment is further configured to generate the piece of music partially based upon a user's selection performance, wherein the selection performance is a function of the user's experimentally determined ability to correctly select facial expressions corresponding to music.

13. The method of claim 11, wherein the computing environment is further configured to generate the piece of music partially based upon a user's selection performance, wherein the selection performance is an estimate of the user's ability to correctly select facial expressions corresponding to music.

14. The method of claim 11, wherein the computing environment is further configured to generate an output corresponding to a reward if the piece of music is generated before the one or more facial expressions are shown to the user and the user correctly selects the facial expression which corresponds to the piece of music.

15. The method of claim 11, wherein the display comprises a computing environment output screen.

16. The method of claim 11, wherein the display comprises a plurality of facial expressions and each facial expression is positioned at a proximal end of a pull ring assembly, wherein there is one facial expression for each pull ring assembly.
